(19) United States
(12) Patent Application Publication
(10) Pub. No.: US 2002/0019459 A1
(43) Pub. Date: Feb. 14, 2002

(54) Dispersants for preparing aqueous pigment pastes

(76) Inventors: Gerhard Albrecht, Tacherting (DE); Hubert Leitner, Haus /Ennstal (AT); Timo Mangel, Leonding (AT); Ellen Reuter, Essen (DE); Angela Ruttgerodt, Leverkusen (DE); Stefan Silber, Krefeld (DE)

Correspondence Address: FROMMER LAWRENCE & HAUG LLP, 745 Fifth Avenue, New York, NY, 10151, US

(21) Appl. No.: 09/827,584

(22) Filed: Apr. 5, 2001

(30) Foreign Application Priority Data
Apr. 8, 2000 (DE) 100 17 667.4

(51) Int. Cl. C09D 11/10; C09D 4/02

(52) U.S. Cl. 523/161; 524/522

(57) ABSTRACT

The invention relates to the use of copolymers containing vinyl-functionalized polyethers for preparing aqueous pigment preparations.

### RELATED APPLICATIONS

This application claims priority to German application No. 100 17 667.4 filed Apr. 4, 2000, herein incorporated by reference.

### FIELD OF THE INVENTION

The invention relates to the use of copolymers with vinyl-functionalized polyethers for preparing aqueous pigment preparations.

### BACKGROUND OF THE INVENTION

1. Description of the Related Art

In order to facilitate and to improve the dispersion of solids in liquid media it is common to employ dispersants, which as surfactants promote wetting of the particulate solids to be dispersed, and aid in the disruption of agglomerates. These dispersants also have a stabilizing effect on the resultant dispersions and prevent reagglomeration or flocculation of the particulate solids. Dispersants are particularly important, for example, for the dispersion of pigments in the preparation of printing inks, paints and other coating materials.

In the preparation of inks and paints, wetting agents and dispersants facilitate the incorporation of pigments and fillers, which are important formulation constituents that significantly determine the visual appearance and the physicochemical properties of coatings. Optimum use requires firstly that these solids are distributed uniformly in paints and inks, and secondly that the state of distribution, once attained, is stabilized. Numerous problems may occur during the preparation and processing of aqueous pigments pastes and in the course of their subsequent use in formulating paints and printing inks:

difficulties in incorporating the pigments, poor wetting

high viscosities of color pastes, inks and paints

sedimentation

vertical separation of pigments (flooding)

horizontal separation of pigments (floating)

low degree of gloss

low hiding power

inadequate transparency

insufficient color strength

poor shade reproducibility, shade shift

excessive tendency of coating materials to run.

There has been no lack of attempts to provide effective dispersing additives for solids, especially pigments. For example, water-soluble polyisocyanate adducts containing hydrophilic polyether chains (EP-A-0731148), acidic poly(meth)acrylates (U.S. Pat. No. 3,980,602, WO 94121701), phosphate esters of polyalkylene oxide block polyesters (WO 97/19948), amine oxides (DE-A-19904603) or alternating copolymers of vinyl monomers and dicarboxylic diesters (WO 96114347, EP-A0791024), especially copolymers based on maleic acid derivatives and vinyl monomers, are described for this purpose.

However, the use of such products is also associated with a multiplicity of disadvantages. Frequently, for instance, high levels of dispersing additives are required; the levels of paste pigmentation that can be achieved are unsatisfactorily low; the stability of the pastes and thus the consistency of their viscosity is inadequate; and flocculation and aggregation cannot always be avoid. The dispersion of very hydrophobic inorganic pigments, in particular, causes problems in many cases. There is often a lack of consistency of shade following storage of the pastes, and a lack of compatibility with various binders. In many cases, the use of known dispersing additives also has an adverse effect on the water resistance or light stability of coatings and, moreover, provides additional stabilization of the unwanted foam which is formed in the course of the preparation and processing. Furthermore, owing to deficiencies in the compatibility of the dispersing resins in numerous vehicles, there is often an undesirable impairment of the gloss.

### SUMMARY OF THE INVENTION

It is, therefore, an object of the present invention to overcome a multiplicity of the above disadvantages for the dispersion of pigments, the aim being, in particular, to exert a positive influence on the storage stability of the pigment concentrates in respect of rheological behavior, flocculation, aggregation and shade shift through extreme hydrolytic resistance of the active substances used, and also on the weathering stability and yellowing resistance of coatings produced from them; furthermore, the use of the dispersing additives should not introduce any volatile organic components into the formulations.

A further objective which has not been achieved to date is to prepare binder-free and co-solvent-free or VOC-free pigment concentrates based on transparent iron oxides with polymeric wetting and dispersing additives (that is, without the use of surface-active substances such as alkylphenol alkoxylates with critical toxicological profiles) while achieving high pigment contents and high transparency.

These objects are achieved, surprisingly, by the use of copolymers with unsaturated dicarboxylic acid derivatives and oxyalkylene glycol alkenyl ethers or polyalkylene oxide alkenyl ethers. Their structure, preparation and use as concrete flow assistants has already been described in EP-A-0736553 (U.S. Pat. No. 5,798,425), herein incorporated by reference.

### DESCRIPTION OF THE INVENTION

Accordingly, a first embodiment of the present invention comprises the use of copolymers based on oxyalkylene glycol alkenyl ethers or polyalkylene oxide alkenyl ethers and unsaturated dicarboxylic acid derivatives as dispersing additives in paints and printing inks or for the preparation of aqueous pigment concentrates comprising:

a) from about 10 to about 90 mol % of structural groups of the formula Ia and/or Ib

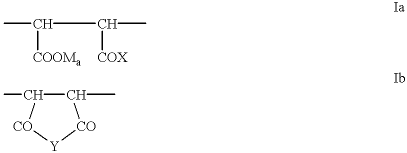

where

M=hydrogen, monovalent or divalent metal cation, ammonium ion, organic amine radical,

a=1 or, if M is a divalent metal cation, is ½,

X=—OMₐ or —O—(CₘHₗₘO)ₙ—(CₘHₗₘO)ₒ—R¹,

where

R¹=is H, an aliphatic hydrocarbon radical, preferably having 1 to 20 carbon atoms, a cycloaliphatic hydrocarbon, preferably having 5 to 8 carbon atoms, an aryl radical, preferably having 6 to 14 carbon atoms which is unsubstituted or substituted,

l=1 or 2,

m=2 to 18,

the index on the hydrogen atom being formed by the product of l and m, and

n=0 to 100, and

o=0 to 100,

—NHR and/or —NR₂² where

R²=R¹, defined above, or O—NH² and also —Q¹N—Q²—NQ³Q⁴, where

Q¹ is a hydrogen atom or a monovalent hydrocarbon radical, preferably having 1 to 24 carbon atoms,

Q² is a divalent alkylene radical, preferably having 2 to 24 carbon atoms,

Q³ and Q⁴ are aliphatic and/or alicyclic alkyl radicals, preferably having 1 to 12 carbon atoms, and unoxidized or oxidized to —Q¹N—Q²—N⁽⁺⁾O⁽⁻⁾Q³Q⁴,

Y=O, NR², R² being as defined above, or

N—Q²—NQ³Q⁴, Q², Q³ and Q⁴being as defined above,

b) from about 1 to about 89 mol % of structural groups of the formula IIa or IIb

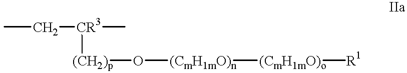

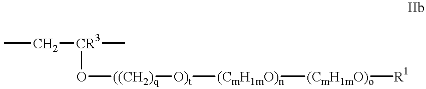

in which

R³=H, aliphatic hydrocarbon radical, preferably having 1 to 5 carbon atoms,

p=0 to 3,

q=0 to 6,t=0 to 3, and

R¹ and l, m, n and o are as defined above,

c) from about 0.1 to about 10 mol % of structural groups of the formula IIIa or IIIb

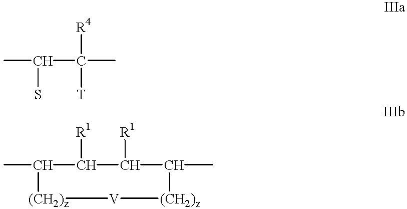

where

R⁴=H, CH₃

S=—H, —COOMₐ, —COOR

where R⁵=aliphatic hydrocarbon, radical, preferably having 3 to 20 carbon atoms, cycloaliphatic hydrocarbon radical, preferably having 5 to 8 carbon atoms, aryl radical, preferably having 6 to 14 carbon atoms

T=—U—O—(CₘHₗₘO)ₙ₋(CₘHₗₘO)ₒ—R⁶

where 1=1 or 2, m=2 to 18, and

n=0 to 100 and o=0 to 100,

U¹=

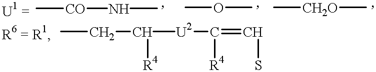

R⁶=

where U²=—NH—CO—, —O—, —OCH₂,

—W—R⁷, where

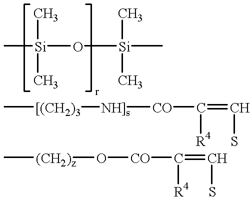

W=

r=2 to 100

R⁷=R¹,

s=1 or 2

z=0 to 4,

—CO—[NH—(CH₂)₃]ₛ—W—R⁷

—CO—O—(CH₂)_{Z}—W—R⁷

—(CH₂)_{Z}—V—(CH₂), —CH=CH—R¹, where

V=—O—CO—C₆H₄—CO—O—or —W—,

—COOR⁵ in the case of S=—COOR⁵ or COOMₐ,

and

V=—O—CO—C₆H₄—CO—O— or —W,

the ligands and indices each being as defined above.

In addition, furthermore, there may be up to about 50 mol %, in particular up to about 20 mol %, based on the sum of the structural groups a), b) and c), of structural groups whose monomer is a vinyl, acrylic acid or methacrylic acid derivative.

The copolymer compounds corresponding to the present invention comprise at least three structural groups a), b), and c). The first structural group a) represents a dicarboxylic acid derivative corresponding to the formula Ia or Ib.

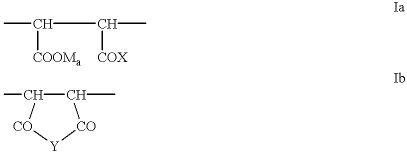

In the dicarboxylic acid derivative corresponding to formula a M is hydrogen, a monovalent or divalent metal cation, ammonium ion, an organic amine radical, and a is 1, or, if M is a divalent cation, ½. In that case, the result together with a group likewise containing Mₐ, where a=½, is a bridge via M, which exists as Mₐ only in theory, where a=½.

The monovalent or divalent metal cation used comprises preferably sodium, potassium, calcium or magnesium ions. Organic amine radicals used are preferably substituted ammonium groups derived from primary, secondary or tertiary C₁- to C₂₀ alkylamines, C₁- to C₂₀ alkanolamines, C₅- to C₈ cycloalkylamines and C₆- to C₁₄ arylamines. Examples of corresponding amines are methylamines, dimethylamine, trimethylamine, ethanolamine, diethanolamine, triethanolmamine, cyclohexylamine, dicyclohexylamine, phenylamine, diphenylamine in the protonated (ammonium) form.

Moreover, X in the formula Ia is —OMₐ or —O—(CₘHₗₘO)ₙ—(CₘHₗₘO)ₒ—R¹, where R¹ is H, an aliphatic hydrocarbon radical, preferably having 1 to 20 carbon atoms, a cycloaliphatic hydrocarbon, preferably having 5 to 8 carbon atoms, an aryl radical, preferably having 6 to 14 carbon atoms, which if desired may also be substituted, l may be 1 or 2, m may be 2 to 18, and n may be 0 to 100 and o may be 0 to 100. The aliphatic hydrocarbon radicals may be linear or branched and also saturated or else unsaturated.

Preferred cycloalkyl radicals are cyclopentyl or cyclohexyl radicals and preferred aryl radicals are phenyl or naphthyl radicals, which may also be substituted, in particular, by hydroxyl, carboxyl or sulfonic acid groups.

Alternatively, X may also be —NHR² and/or —NR₂², which corresponds to the monosubstituted or disubstituted monoamides of the corresponding dicarboxylic acid, it being possible for R² in turn to be identical with R or instead to denote —CO—NH².

Instead of the dicarboxylic acid derivative corresponding to formula Ia, the structural group a) (dicarboxylic acid derivative) may also be present in cyclic form corresponding to the formula Ib, in which case Y may be 0 (acid anhydride) or NR² (acid imide) and R² is as defined above.

As dicarboxylic acid derivatives corresponding to formula Ia or Ib it is also possible to use reaction products with diamines from the group HQ¹N—Q²—NQ³Q⁴, Q¹ being a hydrogen atom or a monovalent hydrocarbon radical, preferably having 1 to 24 carbon atoms, Q² being a divalent alkylene radical, preferably having 2 to 24 carbon atoms, Q³ and Q⁴ being aliphatic and/or alicyclic alkyl radicals, preferably having 1 to 12 carbon atoms, said reaction products having been oxidized with the formation of amine oxide groups attached by way of hemiamide or imide groups.

In the second structural group b) corresponding to the formula IIa or IIb

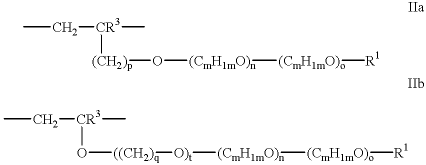

derived from the oxyalkylene glycol alkenyl ethers or polyalkylene oxide alkenyl ethers, R³ is hydrogen or an aliphatic hydrocarbon radical, preferably having 1 to 5 carbon atoms (which may likewise be linear or branched and/or unsaturated). p may adopt values between 0 and 3, q is 0 to 6, t is 0 to 3 and R¹, l, m, n and o are as defined above.

In a preferred embodiment, in formula IIa p is 0, 1 is 2 and m is 2 or 3, so that the structural groups in question are derived from polyethylene oxide or polypropylene oxide vinyl ether.

The third structural group c) corresponds to the formula IIIa or IIIb:

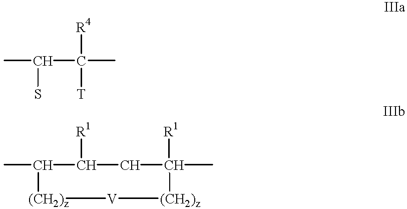

In formula IIIa, R⁴ may be H or CH₃ depending on whether the derivatives in question are acrylic or methacrylic acid derivatives. S here can be —H, COOMₐ or —COOR⁵, a and M being as defined above and it being possible for R⁵ to be an aliphatic hydrocarbon radical, preferably having 3 to 20 carbon atoms, a cycloaliphatic hydrocarbon radical, preferably having 5 to 8 carbon atoms or an aryl radical, preferably having 6 to 14 carbon atoms. The aliphatic hydrocarbon radical may likewise be linear or branched, saturated or unsaturated. The preferred cycloaliphatic hydrocarbon radicals are, in turn, cyclopentyl or cyclohexyl radicals and the preferred aryl radicals are phenyl or naphthyl radicals. If T is —COOR⁵, S is COOMₐ or —COOR⁵. If T and S are COOR⁵, the corresponding structural groups are derived from the dicarboxylic esters.

Besides these ester structural units, the structural groups c) may also possess other hydrophobic structural elements. These include the polyalkylene oxide derivatives where:

T=—U¹—O—(CₘHₗₘO)ₙ—(CₘHₗₘO)ₒ—R⁶

where l is 1 or 2, m is 2 to 18, and n is 0 to 100 and o is 0 to 100.

In this case, the polyalkylene oxide derivatives may be linked via a group U¹ to the ethyl radical of the structural group c) corresponding to formula IIIa, it being possible for U¹ to be —CO—NH—, —O— or —CH₂—O—. In this case, the ethers in question are the corresponding amide, vinyl or alkyl ethers of the structural groups corresponding to formula IIIa. R⁶ in this case may in turn be R¹ (for definition of R¹ see above) or

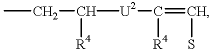

where U² can be —NH—CO—, —O— or —OCH₂— and S is as defined above. These compounds represent polyalkylene oxide derivatives of the bifunctional alkenyl compounds corresponding to formula IIIa.

As a further hydrophobic structural element, the compounds corresponding to formula IIIa may comprise polydimethylsiloxane groups, corresponding to T═—W—R⁷ in the formula scheme IIIa.

W here is

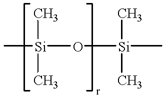

(referred to below as polydimethylsiloxane group), R⁷ may be R¹ and r here may adopt values from 2 to 100.

The polydimethylsiloxane group W may be attached not only directly to the ethylene radical according to formula m a but also by way of the groups

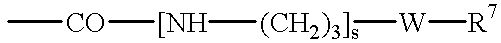

or —CO—O—(CH₂)₂W—R⁷, where R⁷ is preferably R¹ and s can be 1 or 2 and z can be 0 to 4. Furthermore, R⁷ may also be

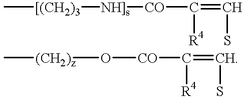

In this case, the compounds in question are the corresponding difunctional ethylene compounds corresponding to the formula m a, which are linked to one another via the corresponding amide or ester groups and in which only one ethylene group has been copolymerized.

The situation is similar with the compounds of formula m a where T═—(CH₂)₂V—(CH₂)_{z}—CH═CH—R¹, where z is about 0 to 4, V can be either a polydimethylsiloxane radical W or a radical —O—CO—C₆H₄—CO—O— and R¹ is as defined above. These compounds are derived from the corresponding dialkenyl-phenyl-dicarboxylic esters or dialkenyl-polydimethylsiloxane derivatives.

In the context of the present invention it is also possible for not just one but instead both ethylene groups of the difunctional ethylene compounds to have been copolymerized. This corresponds essentially to the structural groups corresponding to the formula IIIb,

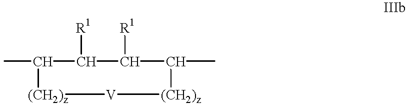

where R¹, V and z are as defined above.

In the context of the present invention, particular preference is given to the use for preparing aqueous or cosolvent-containing pigment concentrates, the copolymers being used in amounts of from about 0.1 to about 200% by weight, based on the pigment.

It is preferred in accordance with the invention if the copolymers comprise from about 10 to about 90 mol % of structural groups of the formula Ia and/or Ib, from about 1 to about 89 mol % of structural groups of the formula IIa and/or IIb, and from about 0.1 to about 10 mol % of structural groups of the formula IIIa and/or IIIb. With particular preference, the copolymers comprise from about 40 to about 55 mol % of structural groups of the formula I a and/or Ib, from about 40 to about 55 mol % of structural groups of the formula IIa and/or IIb, and from about 1 to about 5 mol % of structural groups of the formula IIIa and/or IIIb. In one preferred embodiment, the copolymers of the invention further comprise up to about 50 mol %, in particular up to about 20 mol %, based on the sum of the structural groups a), b) and c), of structural groups whose monomer represents a vinyl, acrylic acid or methacrylic acid derivative.

The monomeric vinyl derivatives are preferably derived from a compound selected from the group consisting of styrene, ethylene, propylene, isobutene and vinyl acetate. As a preferred monomeric acrylic acid derivative, the additional structural groups are derived in particular from acrylic acid, methyl acrylate or butyl acrylate. Methacrylic acid, methyl methacrylate, butyl methacrylate and hydroxyethyl methacrylate are to be regarded as a preferred monomeric methacrylic acid derivative.

A particular advantage of the copolymers used in accordance with the invention is that the molar proportions of the structural units a) to c) may be adjusted so as to give a balanced ratio of polar to nonpolar groups in the corresponding copolymers, thereby permitting targeted control of the surface-active properties of the corresponding products. In particular, the tendency to stabilize introduced air in aqueous formulations, , may be controlled as desired by the selection and proportion of the structural element c).

The number of repeating structural elements is not restricted, although it has proven particularly advantageous to adjust the number of structural elements in such a way that the copolymers have an average molecular mass of from about 1,000 to about 2,000,000, the desired molecular mass being guided primarily by the field of use.

Owing to the alternation of hydrophilic and hydrophobic groups in the macromolecular structure, the aqueous formulations of the copolymers used in accordance with the invention have a cloud point which is preferably between 20 and 98° C. and preferably can be controlled as desired by the proportion of the structural element c).

The copolymers used in accordance with the invention may be prepared in a variety of ways. It is preferred to polymerize from about 10 to about 90 mol % of an unsaturated dicarboxylic acid derivative, from about 1 to about 89 mol % of an oxyalkylene glycol alkylene ether or polyalkylene oxide alkenyl ether and from about 0.1 to about 10 mol % of a vinyl polyalkylene glycol, polyalkylene oxide, polysiloxane or ester compound with the aid of a free-radical initiator.

As the unsaturated carboxylic acid derivative which leads to the structural groups of the formula I a and/or I b, it is preferred to use maleic acid, maleic monoesters, maleic monoamides, maleic ureides, maleic imides and also maleic anhydride or reaction products with diamines which if desired have been oxidized to derivatives containing amine oxide groups, and also fumaric acid. Owing to their hydrolytic stability in aqueous formulations, particular preference is given to the use of copolymers based on maleic acid, maleic monoamides and maleic ureides.

Instead of maleic acid or fumaric acid it is also possible to use their monovalent or divalent metal salts, preferably sodium, potassium, calcium or magnesium salts, their ammonium salts or their salts with an organic amine radical.

As maleic monoesters, use is made in particular of an ester derivative whose alcoholic component is a polyalkylene glycol derivative or polyalkylene oxide derivative of the general formula:

HO—(CₘHₗₘO)ₙ—(CₘHₗₘO)ₒ—R¹

where R¹ is H, an aliphatic hydrocarbon radical, preferably having 1 to 20 carbon atoms (linear or branched and also saturated or else unsaturated), a cycloaliphatic hydrocarbon, preferably having 5 to 8 carbon atoms, an aryl radical, preferably having 6 to 14 carbon atoms, which if desired may be substituted, l can be 1 or 2, m can be 2 to 18, and n can be 0 to 100 and o can be 0 to 100.

The preferred substitutions on the aryl radical are hydroxyl, carboxyl or sulfonic acid groups. In the case of the maleic or fumaric monoamides, the radicals R² of the group —NR, are identical with R¹. The unsaturated dicarboxylic acid derivatives are used preferably in an amount of from about 40 to about 55 mol %.

The second component of the invention for preparing the copolymers of the invention is an oxyalkylene glycol alkenyl ether or polyalkylene oxide alkenyl ether which is used preferably in an amount of from about 40 to about 55 mol %. In the preferred oxyalkylene glycol alkenyl ethers or polyalkylene oxide alkenyl ethers, corresponding to the formulae IVa and IVb

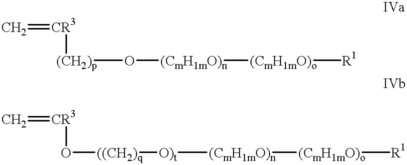

R³ is again hydrogen or an aliphatic hydrocarbon radical, preferably having 1 to 5 carbon atoms (which may likewise be linear or branched and may also be unsaturated); p may adopt values between 0 and 3, q is 0 to 6, t=0 to 3 and R¹, l, m, n and o are as defined above. In one preferred embodiment, in formula IIa p is 0, 1 is 2 and m is 2 or 3, so that the structural groups in question are derived from polyethylene glycol vinyl ether or polypropylene glycol vinyl ether.

As the third component which is an important feature of the invention for introducing the structural groups c) it is preferred to use from about 1 to about 5 mol % of a vinyl-type polyalkylene glycol, polyalkylene oxide, polysiloxane or ester compound. Preferred vinyl-type polyalkylene glycol or polyalkylene oxide compounds used are derivatives corresponding to the formula V

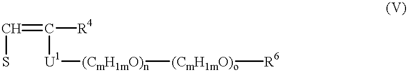

where S may preferably be —H or COOMₐ and U¹ may be —CO—NH—, —O— or —CH₂O—, i.e., the acid amide, vinyl or allyl ethers of the corresponding polyalkylene glycol or polyalkylene oxide derivatives. The values are 1 or 2 for l, 2 to 18 for m, and 0 to 100 for n and 0 to 100 for o. R⁶ may either again be R¹ or may be

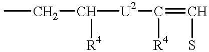

where U² is —NH—CO—, —O— and —OCH₂— and S is —COOMₐ and preferably —H.

where R⁶ is R¹ and R¹ is preferably H, the compounds in question are the polyalkylene glycol or polyalkylene oxide monoamides or ethers of the corresponding acrylic (S═H, R⁴═H), methyacrylic (S═H, R⁴═CH₃) or maleic (S═COOMₐ, R⁴═H) acid derivatives. Examples of such monomers are maleic acid N-(methylpolypropylene glycol)monoamide, maleic acid N-(methoxypolypropylene glycol-polyethylene glycol) monoamide, polypropylene glycol vinyl ether and polypropylene glycol allyl ether.

where R⁶ is not R¹, the compounds in question are bifunctional vinyl compounds whose polyalkylene glycol or polyaklene oxide derivatives are connected to one another via amide or ether groups (—O— or —OCH₂—). Examples of such compounds are polypropylene glycol bismaleamic acid, polypropylene glycol diacrylamide, polypropylene glycol dimethacrylmide, polypropylene glycol divinylether, polypropylene glycol diallyl ether.

Preferred vinyl-type polysiloxane compounds used are derivatives corresponding to the formula VI

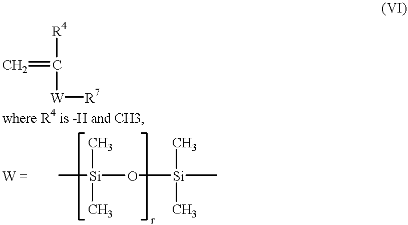

and r is 2 to 100 and R⁷ is preferably R¹. Examples of such monomers are monovinylpolydimethylsiloxanes.

As a further vinyl-type polysiloxane compound, derivatives corresponding to the formula VII are suitable

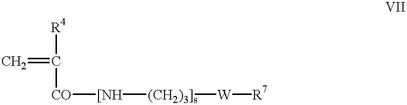

where s may be 1 or 2, R⁴ and W are as defined above and R⁷ is either R¹ or else may be

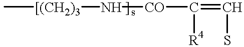

and S is preferably hydrogen.

Examples of such monomers having a vinyl function (R⁷═R¹) are polydimethylsiloxanepropylmaleamic acid or polydimethylsiloxanedipropyleneaminomaleamic acid. Where R⁷ is not R¹, the compounds are divinyl compounds, such as polydimethylsiloxanebis(propylmaleamic acid) or poly-dimethylsiloxanebis(dipropyleneaminomaleamic acid), for example.

A suitable further vinyl-type polysiloxane compound is a preferred derivative corresponding to the formula VIII

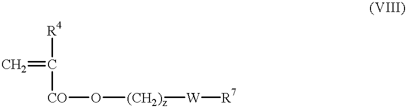

where z may be 0 to 4 and R⁴ and W are as defined above. R⁷ may either be R¹ or else may be

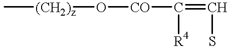

where S is preferably hydrogen. Examples of such monovinyl compounds (R⁷═R¹) are polydimethylsiloxane(1-propyl 3-acrylate) or polydimethylsiloxane(1-propyl 3-methacrylate).

where R⁷ is not R¹, the compounds are divinyl compounds, such as polydimethylsiloxanebis(I-propyl 3-acrylate) or polydimethylsiloxanebis(1-propyl 3-methacrylate), for example.

As vinyl-type ester compounds in the context of the present invention it is preferred to use derivatives corresponding to the formula IX

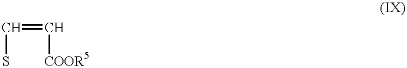

where S is COOMₐ or —COOR⁵ and R⁵ may be an aliphatic hydrocarbon radical, preferably having 3 to 20 carbon atoms, a cycloaliphatic hydrocarbon radical, preferably having 5 to 8 carbon atoms and an aryl radical, preferably having 6 to 14 carbon atoms. a and M are as defined above. Examples of such ester compounds are di-n-butyl maleate or karate or mono-n-butyl maleate or fumarate.

Furthermore, it is also possible to use compounds corresponding to the formula X

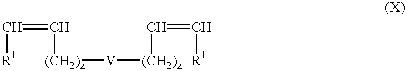

where z may again be 0 to 4 and R¹ possesses the definition already known. V in this case may be W (i.e., a polydimethylsiloxane group), which corresponds to a dialkenylpolydimethylsiloxane compound, such as divinylpolydimethylsiloxane, for example. Alternatively, V may also be

—O—CO—C₆H₄—CO—O—.

These compounds constitute dialkenylphthalic acid derivatives. A typical example of such phthalic acid derivatives is diallyl phthalate.

The molecular masses of the compounds which form the structural group c) may be varied within relatively wide limits and are preferably between about 150 and about 10,000.

In one preferred embodiment, up to about 50 mol %, in particular up to about 20 mol %, based on the monomers containing the structural groups of the formulae I, II and III, of a vinyl, acrylic acid or methacrylic acid derivative are incorporated by copolymerization. Preferred monomeric vinyl derivatives used are styrene, ethylene, propylene, isobutene or vinyl acetate; as a monomeric acrylic acid derivative, preference is given to the use of acrylic acid, methyl acrylate or butyl acrylate; while finally, preferred monomeric methacrylic acid derivatives used are preferably methacrylic acid, methyl methacrylate, butyl methacrylate and hydroxyethyl methacrylate.

The above-mentioned copolymers may be prepared by the customary processes. One particular advantage is that it is possible, preferably, to operate without solvents or else in aqueous solution. In both cases, the reactions involved are at atmospheric pressure and are therefore unobjectionable on safety grounds.

Where the process is conducted in aqueous solution, polymerization takes place at from about 20 to about 100° C. with the aid of a customary free-radical initiator, the concentration of the aqueous solution being adjusted preferably to from about 30 to about 50% by weight. In one preferred embodiment, the free-radical polymerization in this case may be conducted within the acidic pH range, in particular at a pH of between about 4.0 and about 6.5, in which case it is possible to make use of the conventional initiators such as H₂O₂ without the risk of ether cleavage, which would reduce the yield very greatly.

In the process it is preferred to operate by introducing the unsaturated dicarboxylic acid derivative in partially neutralized form in aqueous solution, preferably together with the polymerization initiator, and to meter the other monomers into this initial charge as soon as said initial charge has reached the requisite reaction temperature.

The polymerization auxiliaries, which are able to reduce the activation threshold of the preferably peroxide-type initiator, so that the copolymerization can proceed at relatively low temperatures, are added separately. In another preferred variant, both the unsaturated dicarboxylic acid derivative and the free-radical initiator may be metered into the initial reactor charge in separate feed streams or conjoint feed stream, permitting an ideal solution to the problem of heat dissipation.

The nature of the polymerization initiators, polymerization activators and other auxiliaries used, such as molecular weight regulators, for example, causes relatively little problem;, i.e., initiators employed are the customary free-radical donors, such as hydrogen peroxide, sodium, potassium or ammonium peroxodisulfate, tert-butyl hydroperoxide, dibenzoyl peroxide, sodium peroxide, 2,2′-azobis(2-amidinopropane) dihydrochioride, azobis(isobutyroniurile), etc. Where redox systems are employed, the above-mentioned initiators are combined with activators having a reducing action. Examples of such reducing agents are Fe(II) salts, sodium hydroxymethanesulfinate dihydrate, alkali metal sulfites and metabisulfites, sodium hypophosphite, hydroxylamine hydrochloride, thiourea, etc.

One particular advantage of the copolymers is the fact that they can be prepared even without solvents, which can be done using the customary free-radical initiators at temperatures of between about 60 to about 150° C. On economic grounds, this variant may be employed in particular when the copolymers are to be passed on for use directly in water-free form, since in that case it is possible to dispense with laborious separation of the solvent, especially the water, by spray drying, for example. The copolymers used in accordance with the invention are particularly advantageous for the preparation of aqueous and solvent-free pigment preparations which exhibit good pigment incorporation, advantageous rheology profiles, prevention of sedimentation, high color strength, high homogeneity and flocculation stability in the case of pigment mixtures, high degrees of gloss, high hiding power (or, if desired, high transparency) and also particularly outstanding storage stability of the aqueous formulations, and weathering stability.

Aqueous pigment pastes are prepared using in particular from about 0.1 to about 200% by weight of the copolymers, preferably from about 0.5 to about 50% by weight (based on the weight of the pigments). The copolymers may either be mixed beforehand with the pigments to be dispersed or dissolved directly in the dispersion medium (water, with or without additions of glycol ethers) prior to or simultaneously with the addition of the pigments and any other solids.

The present invention additionally provides for a process for preparing aqueous, highly concentrated, pumpable and flowable pigment preparations, which comprises mixing the polymer for use in accordance with the invention, alone or in combination with at least one further component, with water, scattering the pigment into this mixture with stirring, and dispersing the mixture until the resulting suspension has the required fineness and consistency. Another process for preparing the pigment preparations of the invention comprises first dry mixing a pigment with the copolymers of the invention to give a pulverulent pigment formulation. As and when required, this formulation may be dispersed in water to give the pigment preparation of the invention. A third process of the invention for preparing aqueous, highly concentrated, pumpable and flowable pigment suspensions and pigment pastes comprises adding the copolymer to a water-moist pigment filter cake and incorporating it into the pigment filter cake using, for example, a dissolver, in the course of which the filter cake is liquefied. Examples that may be mentioned of pigments to be dispersed are:

| | |
|---|---|
| Monoazo | C.I. Pigment Brown 25; |
| pigments: | C.I. Pigment Orange 5, 36 and 67; |
| | C.I. Pigment Red 1, 2, 3, 48:4, 49, |
| | 52:2, 53, 57:1, 251, 112, 170 and 184; |
| | C.I. Pigment Yellow 1, 3, 73, 74, |
| | 65, 97, 151 and 183; |
| Diazo | C.I. Pigment Orange 34; |
| pigments: | C.I. Pigment Red 144 and 166 |
| | C.I. Pigment Yellow 12, 13, 17, 83, 113 and 126; |
| Anthra- | C.I. Pigment Yellow 147 and 177; |
| quinone | C.I. Pigment Violet 31; |
| pigments: | |
| Anthra- | C.I. Pigment Yellow 108; |
| pyrimidine | |
| pigments: | |
| Quina- | C.I. Pigment Red 122, 202 and 20; |
| cridone | C.I. Pigment Violet 19; |
| pigments: | |
| Quino- | C.I. Pigment Yellow 138; |
| phthalone | |
| pigments: | |
| Dioxazine | C.I. Pigment Violet 23 and 27; |
| pigments: | C.I. Pigment Yellow 138; |
| Flavan- | C.I. Pigment Yellow 24; |
| throne | |
| pigments: | |
| Indan- | C.I. Pigment Blue 60 and 64; |
| throne | |
| pigments: | |
| Isoin- | C.I. Pigment Orange 69; |
| doline | C.I. Pigment Red 260; |
| pigments: | C.I. Pigment Yellow 139; |
| Isoin-: | C.I. Pigment Orange 61; |
| dolinone | C.I. Pigment Red 257 and 260 |
| pigments: | C.I. Pigment Yellow 109, 110, 173 and 185; |
| Metal | C.I. Pigment Yellow 117 and 153; |
| complex | |
| pigments: | |
| Perinone | C.I. Pigment Orange 43; |
| pigments: | C.I. Pigment Red 194; |
| Perylene | C.I. Pigment Black 31 and 32; |
| pigments: | C.I. Pigment Red 123, 149, 178, 179, 190 and 224; |
| | C.I. Pigment Violet 29; |
| Phthalo- | C.I. Pigment Blue 15, 15:1, 15:2, 15:3, 15:4, 15:6 and 16; |
| cyanine | C.I. Pigment Green 7 and 36; |
| pigments: | |
| Pyran- | C.I. Pigment Orange 51; |
| throne | C.I. Pigment Red 216; |
| pigments: | |
| Thio- | C.I. Pigment Red 88; |
| indigo | |
| pigments: | |
| Triphen- | C.I. Pigment Blue 1, 61, and 62; |
| ylmethane | C.I. Pigment Green 1; |
| pigments: | C.I. Pigment Red 81 and 169; |
| | C.I. Pigment Violet 2 and 3; |
| | C.I Pigment Black 1 (Aniline black) |
| | C.I. Pigment Yellow 101 (Aldazine yellow) |
| Inorganic | |
| pigments: | |
| White | Titanium dioxide (C.I. Pigment White 6), zinc white, |
| pigments: | pigment-grade zinc oxide; zinc sulfide, lithopones; lead white; |
| Black | Iron oxide black (C.I. Pigment Black 11), iron manganese |
| pigments: | black, spinel black (C.I. Pigment Black 27); carbon black |
| | (C.I. Pigment Black 7); |
| Colored | Chromium oxide, chromium oxide hydrate green; chromium |
| pigments: | green (C.I. Pigment Green 48); cobalt green (C.I. |
| | Pigment Green 50); ultramarine green; |
| | Cobalt blue (C.I. Pigment Blue 28 and 36); ultramarine blue; |
| | iron blue (C.I. Pigment Blue 27); manganese blue; |
| | Ultramarine violet; cobalt and manganese violet; |
| | Red iron oxide (C.I. Pigment Red 101); cadmium |
| | sulifoselenide (C.I. Pigment Red 108); molybdate red |
| | (C.I. Pigment Red 104); ultramarine red; |
| | Brown iron oxide, mixed brown, spinel phases and corundum |
| | phases (C.I. Pigment Brown 24, 29 and 31), |
| | Chromium orange; |
| | Yellow iron oxide (C.I. Pigment Yellow 42); nickel titanium |
| | yellow (C.I.. Pigment Yellow 53; C.I. Pigment Yellow 157 |
| | and 164); |
| | chromium titanium yellow, cadmium sulfide and cadmium |
| | zinc sulfide (C.I. Pigment Yellow 37 and 35); chromium |
| | yellow (C.I. Pigment Yellow 34), zinc yellow, alkaline |
| | earth metal chromates, Naples yellow, bismuth vanadate |
| | (C.I. Pigment Yellow 184); |
| Luster | Metallic pigments based on metal oxide-coated metal flakes; |
| pigments: | pearl luster pigments based on metal oxide-coated mica |
| | platelets. |

Examples of fillers which can be dispersed, for example, in aqueous coating materials are those based on kaolin, talc, other silicates, chalk, glass fibers, glass beads, and metal powders. Suitable coating systems into which the pigment preparations of the invention can be incorporated are any desired aqueous one- or two-component coating materials. Examples that may be mentioned are aqueous one-component coating materials such as, for example, those based on alkyd, acrylate, epoxy, polyvinyl acetate, polyester or polyurethane resins, or aqueous two-component coating materials, examples being those based on hydroxyl-containing polyacrylate or polyester resins with melamine resins or optionally blocked polyisocyanate resins as crosslinkers. Similarly, mention may also be made of polyepoxy resin systems.

Water is the preferred solvent for the copolymers for use in accordance with the invention. However, organic solvents, such as glycol ethers or glycol esters, for example, can also be used, alone or in a mixture with water. The addition of solvents may be advantageous, especially for the initial drying behavior of the pigment pastes prepared using the copolymers of the invention.

To prepare the pigment pastes of the invention it is also possible, moreover, to add further water-dispersible polymers not in accordance with the invention, such as, for example, polyacrylate, polyurethane or polysiloxane derivatives.

For preparing the pigment concentrates of the invention it is additionally possible to use further auxiliaries such as defoamers, preservatives, wetting agents, devolatilizers, or prior art antisettling agents, waxes, and Theological additives.

### EXAMPLES

| | | | | | | | Amount of | Addi- |
|---|---|---|---|---|---|---|---|---|
| | Amount of | | Amount of | | Amount of | | additional | tional |
| No. | comp. 1/mol | Comp. 1 | comp. 2/mol | Comp. 2 | comp. 3/mol | Comp. 3 | comp./mol | comp. |
| 1 | 0.334 | Maleic anhydride | 0.310 | Methyl polyethylene glycol | 0.006 | Polypropylene glycol | | |
| | | | | monovinyl ether (MW 500) | | bismaleamic acid | | |
| | | | | | | (MW 2000) | | |
| 2 | 0.334 | Maleic anhydride | 0.310 | Methyl polyethylene glycol | 0.006 | Polydimethylsiloxane | | |
| | | | | monovinyl ether (MW 500) | | bisdipropyleneamino- | | |
| | | | | | | maleamic acid | | |
| | | | | | | (MW 2000) | | |
| 3 | 0.334 | Maleic anhydride | 0.310 | Methyl polyethylene glycol | 0.006 | Polypropylene glycol | | |
| | | | | monovinyl ether (MW 1000) | | bismaleamic acid | | |
| | | | | | | (MW 2000) | | |
| 4 | 0.334 | Maleic anhydride | 0.310 | Methyl polyethylene glycol | 0.006 | Polypropylene glycol | | |
| | | | | monovinyl ether (MW 2000) | | bismaleamic acid | | |
| | | | | | | (MW 2000) | | |
| 5 | 0.334 | Maleic anhydride | 0.310 | Methyl polyethylene glycol | 0.006 | Polypropylene glycol | 0.334 | Styrene |
| | | | | monovinyl ether (MW 1000) | | bismaleamic acid | | |
| | | | | | | (MW 2000) | | |
| 6 | 0.334 | Maleic anhydride | 0.310 | Methyl polyethylene glycol | 0.006 | Polypropylene glycol | | |
| | | | | monovinyl ether | | bismaleamic acid | | |
| | | | | (85% EO/15% PO, MW 1000) | | (MW 2000) | | |
| 7 | 0.334 | Maleic anhydride | 0.310 | Methyl polyethylene glycol | 0.006 | Polypropylene glycol | | |
| | | | | monovinyl ether | | bismaleamic acid | | |
| | | | | (70% EO/30% PO, MW 1000) | | (MW 2000) | | |
| 8 | 0.21 | Maleic anhydride | 0.310 | Methyl polyethylene glycol | 0.006 | Polypropylene glycol | | |
| | | | | monovinyl ether | | bismaleamic acid | | |
| | | | | (70% EO/30% PO, MW 1000) | | (MW 2000) | | |
| 9 | 0.334 | Maleic anhydride | 0.210 | Methyl polyethylene glycol | 0.006 | Polypropylene glycol | | |
| | | | | monovinyl ether | | bismaleamic acid | | |
| | | | | (70% EO/30% PO, MW 1000) | | (MW 2000) | | |
| 10 | 0.334 | Maleic anhydride | 0.210 | Methyl polyethylene glycol | 0.006 | Polypropylene glycol | 0.334 | Styrene |
| | | | | monovinyl ether | | bismaleamic acid | | |
| | | | | (70% EO/30% PO, MW 1000) | | (MW 2000) | | |

Comparative Example 1: aqueous solution of a sodium polyacrylate (Tego ® Dispers 715 W)
Comparative Example 2: aqueous solution of an acrylate copolymer (Tego ® Dispers 745 W)
Comparative Example 3: aqueous solution of a maleic anhydride-styrene copolymer modified with polyether side chains (Tego ® Dispers 750 W)

### Preparation Example 1

270 g of water were introduced into a reaction vessel with thermometer, stirrer, reflux condenser and two connections for separate feeds. 32.7 g of maleic anhydride and 25.0 g of 50% strength aqueous sodium hydroxide solution were added with stirring, the temperature being held below 30° C. by cooling. Subsequently, 100 mg of iron sulfate heptahydrate and 18.5 g of 30% strength hydrogen peroxide were added with stirring, and, from separate feed vessels, a solution of 5.1 g of sodium hydroxymethanesulfinate dehydrate and 12.5 g of water (feed stream 1) was added over 75 minutes and a solution of 155 g of methyl polyethylene glycol monovinyl ether and 12.1 g of polypropylene glycol bismaleamic acid (feed stream 2) was added over 60 minutes.

After the end of the additions, stirring was continued at 35° C. for 30 minutes and the reaction mixture was cooled to 25° C. A pH of 7.60 was established by adding 20% strength aqueous sodium hydroxide solution. This gave a yellow-colored, slightly cloudy aqueous formulation which had a solids content of 37.4% by weight.

### Preparation Example 2

The procedure described under Example 1 was repeated but with the following composition of feed stream 2:

155.0 g of methyl polyethylene glycol monovinyl ether and 7.4 g of polydimethylsiloxane bisdipropylenearinomaleic acid. After the end of the additions, the reaction mixture had a pH of 5.02 and was neutralized with 20% strength aqueous sodium hydroxide solution (58.3 g). 35.5% by weight of solids were found in the end product. Examples 3-10 were prepared analogously or by processes corresponding to the prior art.

Preparation of the Pigment Pastes:

To prepare the pigment pastes, the inventive and noninventive dispersing additives were first dissolved beforehand in water to give 40% strength solutions, which were mixed with water and auxilianes, and then the pigments were added. Dispersion took place following the addition of grinding media (glass beads 2 to 3 mm, same volume as the pigment paste) for 1 h (titanium dioxide) or 2 h (other pigments) in a Skandex shaker with air cooling.

Formulation of the White Pastes (Titanium Dioxide):

The white pastes were formulated as follows (amounts in % by weight):

| | |
|---|---|
| 16.4 | water |
| 12.3 | additive solution, 40% strength |
| 1.0 | defoamer (Tego ® Foamex 810, Tego Chemie Service GmbH) |
| 70.0 | titanium dioxide 2160 (Kronos) |
| 0.3 | Aerosil ® A 200 (Degussa) |

Formulation of the Black Pastes (Carbon Black):

The black pastes were formulated as follows (amounts in % by weight):

| | |
|---|---|
| 60.3 | water |
| 22.3 | additive solution, 40% strength |
| 1.0 | defoamer (Tego ® Foamex 810 or Tego ® Foamex 830, Tego |
| | Chemie Service GmbH) |
| 1.4 | AMP 90 (Angus) |
| 15.0 | pigment-grade carbon black FW 200 (Degussa) |

Formulation of the Red Iron Oxide Pastes (Iron Oxide):

The iron oxide pastes were formulated as follows (amounts in % by weight):

| | |
|---|---|
| 40.0 | water |
| 24.0 | additive solution, 40% strength |
| 1.0 | defoamer (Tego ® Foamex 810 or Tego ® Foamex 830, Tego |
| | Chemie Service GmbH) |
| 35.0 | Sicotrans ® 2817 (BASE) |

Test Coating Materials:

Transparent baking enamel based on a modified alkyd resin (amounts in % by weight)

| | |
|---|---|
| 70.88 | Resydrol ® VWA 5477, 40% strength (Hoechst) |
| 0.14 | defoamer (Tego ® Foamex 810 or Tego ® Foamex 830, Tego |
| | Chemie Service GmbH) |
| 0.68 | Bentone ® SD 1 (Rheox) |
| 8.24 | Maprenal ® ME 900 (Hoechst) |
| 0.14 | triethanolamine |
| 19.10 | water |
| 0.68 | Additol ® XW 395 (Hoechst) |
| 0.14 | Additiol ® XW 329 |

Introduce item 1 initially and add the other components with sting.

Dispersion Clearcoat:

| | |
|---|---|
| 97.0 | Neocryl ® XX 90 (Zeneca) |
| 3.0 | Texanol ® |

To prepare pigmented paints, in each case 40.0 g of clearcoat were introduced initially, white paste and color paste were added in a ratio of 25:1 (solids), or 4.5 g of the iron oxide paste, and the mixture was homogenized The samples were applied by knife-coating in a wet film thickness of 100 μm and were either baked at 150° C. for 15 minutes following a flash-off period of 20 minutes (stoving enamel) or were dried at room temperature (dispersion coatings).

Test of the Paste Stabilities:

order to determine the paste stabilities, the achievable initial viscosities and the viscosities after ten weeks of storage at 40° C. were determined at two different shear rates (20 l/s and 1000 l/s).

Titanium dioxide paste:

| | Viscosity/ | Viscosity/ | Viscosity/Pas | Viscosity/Pas |
|---|---|---|---|---|
| | Pas | Pas | after 10 weeks | after 10 weeks |
| | immediate | immediate | at 40° C. | at 40° C. |
| Example | at 20 l/s | at 1000 l/s | at 20 l/s | at 1000 l/s |
| 1 | 0.64 | 0.13 | 0.84 | 0.28 |
| 2 | 0.68 | 0.17 | 0.82 | 0.33 |
| 3 | 0.65 | 0.16 | 0.78 | 0.32 |
| 4 | 0.68 | 0.19 | 0.77 | 0.30 |
| 5 | 0.58 | 0.12 | 0.73 | 029 |
| 6 | 0.59 | 0.14 | 0.74 | 0.27 |
| 7 | 0.58 | 0.13 | 0.77 | 0.26 |
| 8 | 0.64 | 0.16 | 0.79 | 0.30 |
| 9 | 0.63 | 0.15 | 0.81 | 0.32 |
| 10 | 0.65 | 0.17 | 0.80 | 0.31 |
| Compar. 1 | 0.78 | 0.16 | 1.33 | 0.57 |
| Compar. 2 | 0.73 | 0.16 | 1.35 | 0.59 |
| Compar. 3 | 0.76 | 0.18 | 1.28 | 0.55 |

Carbon black paste:

| | Viscosity/ | Viscosity/ | Viscosity/Pas | Viscosity/Pas |
|---|---|---|---|---|
| | Pas | Pas | after 10 weeks | after 10 weeks |
| | immediate | immediate | at 40° C. | at 40° C. |
| Example | at 20 l/s | at 1000 l/s | at 20 l/s | at 1000 l/s |
| 1 | 0.14 | 0.12 | 0.23 | 0.17 |
| 2 | 0.16 | 0.13 | 0.25 | 0.19 |
| 3 | 0.17 | 0.14 | 0.27 | 0.21 |
| 4 | 0.19 | 0.16 | 0.32 | 0.24 |
| 5 | 0.15 | 0.13 | 0.24 | 021 |
| 6 | 0.14 | 0.12 | 0.23 | 0.18 |
| 7 | 0.17 | 0.15 | 0.26 | 0.19 |
| 8 | 0.16 | 0.13 | 0.25 | 0.19 |
| 9 | 0.15 | 0.12 | 0.23 | 0.17 |
| 10 | 0.16 | 0.13 | 0.24 | 0.18 |
| Compar. 1 | 0.43 | 0.35 | 0.77 | 0.45 |
| Compar. 2 | 0.41 | 0.34 | 0.71 | 0.43 |
| Compar. 3 | 0.38 | 0.31 | 0.65 | 0.39 |

Iron oxide paste:

| | Viscosity/ | Viscosity/ | Viscosity/Pas | Viscosity/Pas |
|---|---|---|---|---|
| | Pas | Pas | after 10 weeks | after 10 weeks |
| | immediate | immediate | at 40° C. | at 40° C. |
| Example | at 20 l/s | at 1000 l/s | at 20 l/s | at 1000 l/s |
| 1 | 0.41 | 0.32 | 0.44 | 0.35 |
| 2 | 0.38 | 0.28 | 0.40 | 0.30 |
| 3 | 0.35 | 0.26 | 0.37 | 0.30 |
| 4 | 0.39 | 035 | 0.41 | 0.37 |
| 5 | 0.38 | 0.32 | 0.40 | 033 |
| 6 | 0.40 | 0.33 | 0.43 | 0.36 |
| 7 | 0.36 | 0.31 | 0.38 | 0.33 |
| 8 | 0.39 | 0.33 | 0.43 | 0.37 |
| 9 | 0.38 | 0.34 | 0.40 | 0.36 |
| 10 | 0.36 | 0.30 | 0.38 | 0.32 |
| Compar. 1 | 6.44 | 3.63 | 7.55 | 4.22 |
| Compar. 2 | 5.78 | 2.56 | 6.27 | 4.06 |
| Compar. 3 | 0.55 | 0.42 | 1.94 | 1.22 |

The good stability of the pigment pastes of the invention are readily evident from the low increase in viscosity in each case. When the copolymers of Comparative Examples 1 to 3 were used, not in accordance with the invention, it was impossible to formulate storage-stable pigment concentrates. Highly pigmented concentrates with transparent iron oxide can be prepared in a flowable form only with some copolymers of the invention.

Test of the Dispersing Properties:

Using fresh pastes and pastes stored at 40° C. for ten weeks, the test formulations were prepared and drawn down in a wet film thickness of 100 μm; after drying for six minutes, a rub out test was performed on ⅓ of the coated area. Baking or drying overnight, respectively, was followed after 24 hours in each case by calorimetric measurement of the drawdowns by means of an XP 68 spectrophotometer from X-Rite. Gloss and haze were determined using the haze-gloss instrument from Byk-Gardner, the transparency was assessed in accordance with a school grade system (1=very good, 2=good, 3=satisfactory, 4=adequate, 5=poor and 6=unsatisfactory).

Coloristic Data:

| | | | | |
|---|---|---|---|---|
| | Immediate | | After 10 weeks at 40° C. | |
| Example | Gloss (20°) | Rubout | Gloss (20°) | Rubout |

Dispersion system with white and black paste:

| | | | | |
|---|---|---|---|---|
| 1 | 63 | 0.5 | 61 | 0.5 |
| 2 | 61 | 0.6 | 60 | 0.5 |
| 3 | 64 | 0.4 | 62 | 0.4 |
| 4 | 62 | 0.4 | 62 | 0.4 |
| 5 | 67 | 0.4 | 66 | 0.4 |
| 6 | 62 | 0.5 | 61 | 0.6 |
| 7 | 61 | 0.4 | 62 | 0.4 |
| 8 | 63 | 0.4 | 61 | 0.3 |
| 9 | 64 | 0.5 | 63 | 0.4 |
| 10 | 68 | 0.4 | 67 | 0.4 |
| Compar. 1 | 50 | 12 | 42 | 1.6 |
| Compar. 2 | 55 | 0.9 | 43 | 1.4 |
| Compar. 3 | 61 | 0.5 | 58 | 0.9 |

Baking system with white and black paste:

| | | | | |
|---|---|---|---|---|
| 1 | 75 | 0.7 | 76 | 0.7 |
| 2 | 80 | 0.8 | 78 | 0.7 |
| 3 | 77 | 0.6 | 75 | 0.7 |
| 4 | 79 | 0.6 | 77 | 0.6 |
| 5 | 82 | 0.7 | 80 | 0.6 |
| 6 | 76 | 0.6 | 74 | 0.7 |
| 7 | 75 | 0.7 | 76 | 0.6 |
| 8 | 78 | 0.6 | 77 | 0.7 |
| 9 | 77 | 0.7 | 75 | 0.7 |
| 10 | 84 | 0.6 | 83 | 0.6 |
| Compar. 1 | 68 | 1.6 | 68 | 2.3 |
| Compar. 2 | 72 | 1.4 | 70 | 2.0 |
| Compar. 3 | 80 | 0.8 | 78 | 1.6 |

In comparison to the polymers of Comparative Examples 1 to 3, the copolymers used in accordance with the invention did not cause any deterioration in the weathering stability of the coating films - copolymers free from aromatic vinyl units were notable for very good yellowing stability.

The above description is intended to be illustrative and not limiting. Various changes or modification in the embodiments described herein may occur to those skilled in the art. These can be made without departing from the scope and spirit of the invention.

What is claimed is:

1. A process for dispersing a pigment for a paint, printing ink or pigment paste which comprises adding to the pigment co-polymer based on oxyalkyleneglycol-alkylenyl ethers and unsaturated dicarboxylic acid derivatives comprising:
a) from about 10 to about 90 mol % of structural groups of the formula Ia and/or Ib 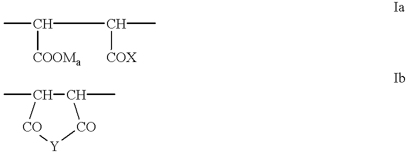
where
M hydrogen, monovalent or divalent metal cation, ammonium ion, organic amine radical,
a=1 or, if M is a divalent metal cation, is ½,
X=—OMₐ or —O—(CₘHₗₘO)ₙ—(CₘHₗₘO)ₒ—R¹,
where
R¹ =is H, an aliphatic hydrocarbon radical, a cycloaliphatic hydrocarbon, an aryl radical which is unsubstituted or substituted,
l=1 or 2,
m=2 to 18,
the index on the hydrogen atom being formed by the product of l and m, and
n=0 to 100, and
o=0 to 100,
p=0 to 3,
q=0 to 6, t=0 to 3, and
R¹ and l, m, n and o are as defined above,
c) about 0.1 to about 10 mol % structural groups of the formula IIIa or IIIb 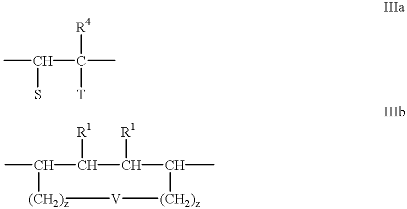
where
R⁴=H, CH₃
S=—H,—COOMₐ, —COOR⁵
where R⁵=aliphatic hydrocarbon radical, cycloaliphatic hydrocarbon radical, aryl radical
T=—U¹—O—(CₘHₗₘO)ₙ—(CₘHₗₘO)ₒ—R⁶
where l=1 or 2, m=2 to 18, and
n=0 to 100 and o=0 to 100,
U¹=—CO—NH—,—O—,—CH₂O—, 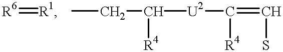
where U²=—NH—CO—,—O—,—OCH₂,—W—R⁷, where
—NHR² and/or —NR₂² where
R²=R¹ or —CO—NH² and also
—Q¹N—Q²—NQ³Q⁴, where
Q¹ is a hydrogen atom or a monovalent hydrocarbon radical;
Q² is a divalent alkylene radical;
Q³ and Q⁴ are aliphatic and/or alicyclic alkyl radicals; and
unoxidized or oxidized to —Q¹N—Q²—N⁽⁺⁾O⁽⁻⁾Q³Q⁴,
Y=O, NR²,R² being as defined above, or
N—Q²—NQ³Q⁴, Q², Q³ and Q⁴ being as defined above,
b) from about 1 to about 89 mol % of structural groups of the formula IIa or IIb 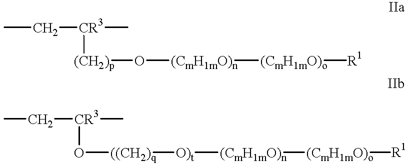
in which
R³=H, aliphatic hydrocarbon radical, 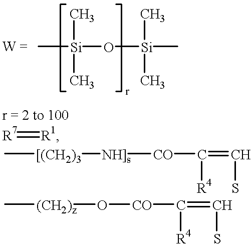
s=1 or 2
z=0 to 4,
—CO—[NH—(CH₂)₃]ₛ—W—R⁷
—CO—O—(CH₂)_{Z}—W—R⁷
—(CH₂)_{Z}—V—(CH₂)_{Z}—CH═CH—R¹, where
V=—O—CO—C₆H₄—CO—O— or —W—,
—COOR⁵ in the case of S═—COOR⁵ or COOMₐ,
and
V═—O—CO—C₆H₄—CO—O— or —W,
the ligands and indices each being as defined above.

2. The method according to claim 1, wherein the copolymers comprise
a) from 10 to 90 mol % of structural groups of the formula Ia and/or Ib 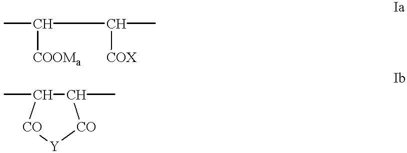
where
M=hydrogen, monovalent or divalent metal cation, ammonium ion, organic amine radical,
a=1 or, if M is a divalent metal cation, is ½,
where
R¹=is H, an aliphatic hydrocarbon radical having 1 to 20 carbon atoms, a cycloaliphatic hydrocarbon having 5 to 8 carbon atoms, an aryl radical having 6 to 14 carbon atoms which is unsubstituted or substituted,
l=1 or 2,
m=2 to 18,
the index on the hydrogen atom being formed by the product of l and m, and
n 0 to 100, and
o=0 to 100,
—NHR² and/or —NR₂² where
R²=R¹ or —CO—NH² and also
—Q¹N—Q²—NQ³Q⁴, where
Q¹ is a hydrogen atom or a monovalent hydrocarbon radical having 1 to 24 carbon atoms,
Q² is a divalent alkylene radical having 2 to 24 carbon atoms,
Q³ and Q⁴ are aliphatic and/or alicyclic alkyl radicals having 1 to 12 carbon atoms, and
unoxidized or oxidized to —Q¹N—Q² N(+)O(−)Q³Q⁴,
Y=O, NR², R² being as defined above, or N—Q²—NQ³Q⁺
where
Q², Q³ and Q⁴being as defined above,
b) from 1 to 89 mol % of structural groups of the formula IIa or IIb 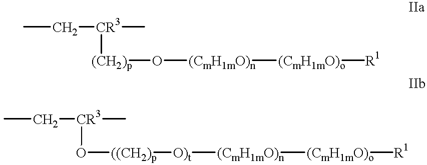
in which
R³=H, aliphatic hydrocarbon radical having 1 to 5 carbon atoms,
p=0 to 3,
q=0 to 6, t=0 to 3, and
R¹ and l, m, n and o are as defined above,
c) 0.1 to 10 mol % structural groups of the formula IIIa or IIIb 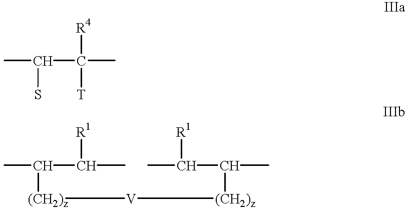
where
R⁴=H, CH₃
where R⁵=aliphatic hydrocarbon radical having 3 to 20 carbon atoms, cycloaliphatic hydrocarbon radical having 5 to 8 carbon atoms, aryl radical having 6 to 14 carbon atoms
T=—U¹—O—(CₘHₗₘO)ₙ—O—(CₘHₗₘO)ₙ—(CₘHₗₘO)ₒ—R⁶
where l=1 or 2, m=2 to 18, and
n=0 to 100 and o=0 to 100,
U¹═—CO—NH—, —O—, —CH₂O—, 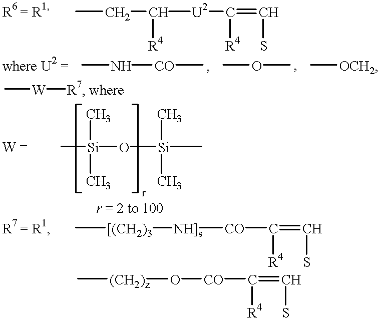
s=1 or 2
z=0 to 4,
—CO—[NH—(CH₂)₃]ₛ—W—R⁷
—CO—O—(CH₂)_{Z}—W—R⁷
—(CH₂)_{Z}—V—(CH₂)_{Z}—CH═CH—R¹, where
V=—CO—C₆H₄—CO—O— or —W—,
—COOR⁵ in the case of S=—COOR⁵ or COOMₐ,
and
V=—O—CO—C₆H₄—CO—O— or —W,
the ligands and indices each being as defined above;

3. The method according to claim 1, where, in the copolymers, up to about 50 mol %, based on the sum of a structural groups a), b) and c), of components, the monomers of which are vinyl, acrylic acid or methacrylic acid.

4. The method according to claim 1, where, in the copolymers, up to about 20 mol %, based on the sum of structural groups a), b) and c), of components, the monomers of which are vinyl, acrylic acid or methacrylic acid.

5. The method according to claim 1, where the copolymers comprise about 40 to about 55 mol % of a component of formula Ia and Ib; about 40 to about 55 mol % of a component of formula II; and from about 0.1 to about 5 mole % of a component of formula III or IIIb.

6. The method according to claim 1, where the copolymers comprise a component of structural formula Ia and/or Ib which is a dicarboxylic acid derivative containing at least one amino oxide group.

7. The method according to claim 1, where the copolymers comprise a component of structural formula IIIa and/or IIIb which are obtained by a process comprising vinyl-type polysiloxane compounds.

8. A dispersed pigment obtained by the process according to claim 1.

9. A printing ink, paint or pigment paste which comprises a dispersed pigment according to claim 8.

10. An aqueous pigment concentrate which comprises
a pigment;
a copolymer based on oxyalkylenealkylglycol-alkylene ethers and unsaturated dicarboxylic acid derivative comprising
a) from about 10 to about 90 mol % of structural groups of the formula Ia and/or Ib 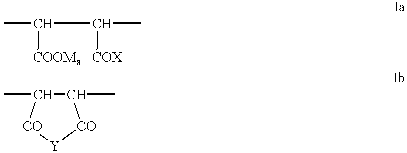
where
M=hydrogen, monovalent or divalent metal cation, ammonium ion, organic amine radical,
a=1 or, if M is a divalent metal cation, is ½,
X=—OMₐ or —O—(CₘHₗₘO)ₙ—(CₘHₗₘO)ₒ—R¹,
where
R¹=is H, an aliphatic hydrocarbon radical;
a cycloaliphatic hydrocarbon;
an aryl radical which is unsubstituted or substituted.
l=1 or 2,
m=2 to 18,
the index on the hydrogen atom being formed by the product of l and m, and
n=0 to 100, and
o=0 to 100,
—NHR² and/or —NR₂² where
R²═R¹ or —CO—NH₂ and also
—Q¹N—Q²—NQ³Q⁴, where
Q¹ is a hydrogen atom or a monovalent hydrocarbon radical;
Q² is a divalent alkylene radical;
Q³ and Q⁴ are aliphatic and/or alicyclic alkyl radicals, and unoxidized or oxidized to —Q¹N—Q²—N(+)O(−)Q³Q⁴,
Y=O, NR², R² being as defined above, or N—Q²—NQ³Q⁴,
where
Q^{2,} Q³ and Q⁴being as defined above,
b) from about 1 to about 89 mol % of structural groups of the formula IIa or IIb 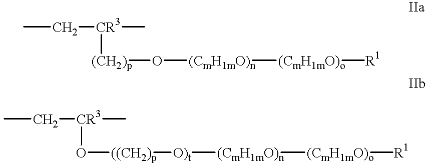
in which
R³=H, aliphatic hydrocarbon radical,
p=0 to 3,
q=0 to 6, t=0 to 3, and
R¹ and l, m, n and o are as defined above,
c) about 0.1 to about 10 mol % structural groups of the formula IIIa or IIIb 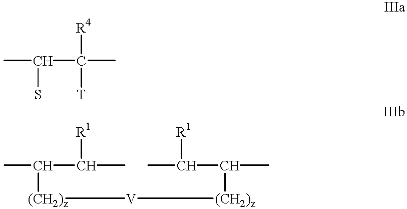
where
R⁴=H, CH₃
S=—H, —COOMₐ, —COOR⁵
where R⁵=aliphatic hydrocarbon radical; cycloaliphatic hydrocarbon radical; aryl radical.
T=—U¹—O—(CₘHₗₘO)ₙ—(CₘHₗₘO)ₒ—R⁶
where l=1 or 2, m=2 to 18, and
n=0 to 100 and o=0 to 100,
U¹═—CO—NH—, —O—, —CH₂O—, 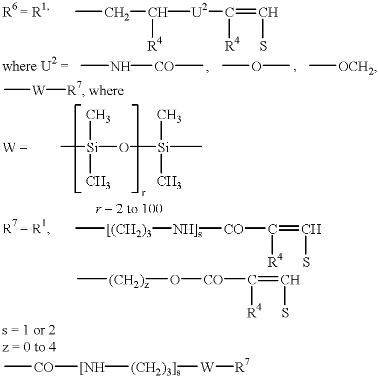
—CO—O—(CH₂)_{Z}—W—R⁷
—(CH₂)_{Z}—V—(CH₂)_{Z}—CH═CH—R¹, where
V═—O—CO—C₆H₄—CO—O— or —W—,
—COOR⁵ in the case of S═—COOR⁵ or COOMₐ,
and
V═—O—CO—C₆H₄—CO—O— or —W, the ligands and indices each being as defined above;
water;
optionally a co-solvent; and
optionally an auxiliary.

11. The aqueous pigment concentrate according to claim 10, wherein a co solvent is present and it is a glycol ester or a glycol ester.

12. The aqueous pigment concentrate according to claim 10, wherein the copolymer based on oxyalkylenealkylglycol-alkylene and unsaturated dicarboxylic acid derivative comprises:
a) from 10 to 90 mol % of structural groups of the formula Ia and/or Ib 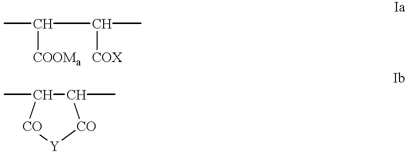
where
M=hydrogen, monovalent or divalent metal cation, ammonium ion, organic amine radical,
a=1 or, if M is a divalent metal cation, is ½,
X=—Mₐ or —O—(CₘHₗₘO)ₙ—(CₘHₗₘO)ₒ—R¹,
where
R¹=is H, an aliphatic hydrocarbon radical having 1 to 20 carbon atoms, a cycloaliphatic hydrocarbon having 5 to 8 carbon atoms, an aryl radical having 6 to 14 carbon atoms which is unsubstituted or substituted,
l=1 or 2,
m=2 to 18,
the index on the hydrogen atom being formed by the product of l and m, and
n=0 to 100, and
o=0 to 100,
—NHR² and/or —NR₂² where
R²=R¹ or —CO—NH² and also
—Q¹N—Q²—NQ³Q⁴, where
Q¹ is a hydrogen atom or a monovalent hydrocarbon radical having 1 to 24 carbon atoms,
Q² is a divalent alkylene radical having 2 to 24 carbon atoms,
Q³ and Q⁴ are aliphatic and/or alicyclic alkyl radicals having 1 to 12 carbon atoms, and
unoxidized or oxidized to —Q¹N—Q²—N(+)O(−)Q³Q⁴,
Y═O, NR², R² being as defined above, or N—Q²—NQ³
where
Q^{4,} Q² and Q⁴ being as defined above,
b) from 1 to 89 mol % of structural groups of the formula IIa or IIb 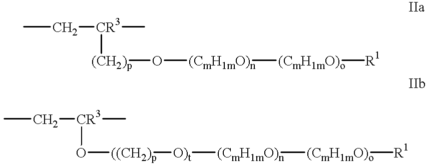
in which
R³=H, aliphatic hydrocarbon radical having 1 to 5 carbon atoms,
p=0 to 3,
q=0 to 6, t=0 to 3, and
R¹ and l, m, n and o are as defined above,
c) 0.1 to 10 mol % structural groups of the formula IIIa or IIIb 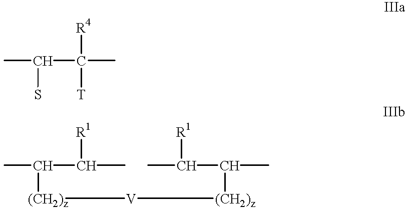
where
R⁴=H, CH₃
S=—H, —COOMₐ, —COOR⁵
where R⁵=aliphatic hydrocarbon radical having 3 to 20 carbon atoms, cycloaliphatic hydrocarbon radical having 5 to 8 carbon atoms, aryl radical having 6 to 14 carbon atoms
T=—U¹—O—(CₘHₗₘO)ₙ—(CₘHₗₘO)ₒ—R⁶
where l=1 or 2, m=2 to 18, and
n=0 to 100 and o=0 to 100,
U¹=—CO—NH—, —O—, —CH₂O—, 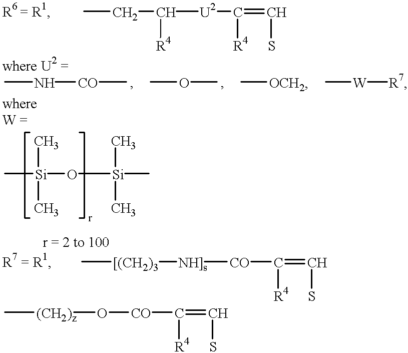 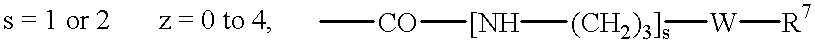
—CO—O—(CH₂)_{Z}—W—R⁷
—(CH₂)_{Z}—V—(CH₂)_{Z}—CH═CH—R¹, where
V=—O—CO—C₆H₄—CO—O— or —W—,
—COOR⁵ in the case of S=—COOR⁵ or COOMₐ,
and
V=—O—CO—C₆H₄—CO—O— or —W,
the ligands and indices each being as defined above.

13. The aqueous pigment concentrate according to claim 10, which contains about 0.1 to about 200% by weight of copolymers, based on the amount of pigment.

14. The aqueous pigment concentrate according to claim 10, wherein the pigment is an inorganic pigment.

15. The aqueous pigment concentrate according to claim 14, wherein the pigment is an iron oxide.

16. The aqueous pigment concentrate according to claim 14, wherein the pigment is a transparent iron oxide.

17. A coating system which comprises an aqueous pigment concentrate according to claim 10 and an aqueous coating material.

18. The coating system according to claim 17, wherein the coating material is a one-component coating material which is based on alkyl, acrylate, epoxy, polyvinyl acetate, polyester or polyurethane resins.

19. The coating system according to claim 17, wherein the coating material is two-component coating material based on hydroxyl-containing polyacrylate or polyester resins with melamine resins or optionally blocked polyisocyanate resins as cross linkers, or polyepoxide resins.

20. A pigment concentrate which comprises
a pigment;
a copolymer based upon oxyalkylenealkylglycol-alkylene ethers and unsaturated dicarboxylic acid derivatives comprising:
a) from about 10 to about 90 mol % of structural groups of the formula Ia and/or Ib 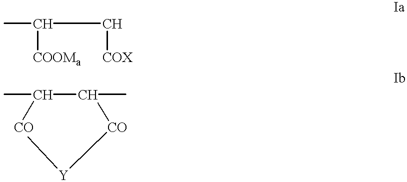
where
M=hydrogen, monovalent or divalent metal cation, ammonium ion, organic amine radical,
a=1 or, if M is a divalent metal cation, is ½,
X=—OMₐ or —O—(CₘHₗₘO)ₙ—(CₘHₗₘO)ₒ—R¹,
where
R¹=is H, an aliphatic hydrocarbon radical, a cycloaliphatic hydrocarbon, an aryl radical which is unsubstituted or substituted,
l=1 or 2,
m=2 to 18,
the index on the hydrogen atom being formed by the product of l and m, and
n=0 to 100, and
o=0 to 100,
—NHR² and/or —NR₂² where
R²=R¹ —CO—NH₂ and also
—Q¹N—Q²—NQ³Q⁴, where
Q¹ is a hydrogen atom or a monovalent hydrocarbon radical;
Q² is a divalent alkylene radical;
Q³ and Q⁴ are aliphatic and/or alicyclic alkyl radicals; and
unoxidized or oxidized to —Q¹N—Q²—N(+)O(—)Q³Q⁴,
Y=O, NR², R² being as defined above, or N—Q²—NQ³Q⁴,
where
Q², Q³ and Q⁴being as defined above,
b) from about 1 to about 89 mol % of structural groups of the formula IIa or IIb 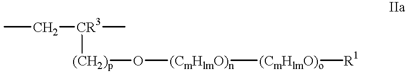 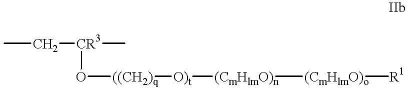
in which
R³=H, aliphatic hydrocarbon radical,
p=0 to 3,
q=0 to 6, t=0 to 3, and
R¹ and l, m, n and o are as defined above,
c) about 0.1 to about 10 mol % structural groups of the formula IIIa or IIIb 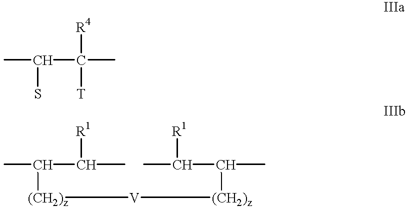
where
R⁴=H, CH₃
S=—H, —COOMₐ, —COOR⁵
where R⁵=aliphatic hydrocarbon radical, cycloaliphatic hydrocarbon radical, aryl radical
T=—U¹—O—(CₘHₗₘO)ₙ—(CₘHₗₘO)ₒ—R⁶
where l=1 or 2, m=2 to 18, and
n=0 to 100 and o=0 to 100,
U¹=—CO—NH—, —O—, —CH₂O—, 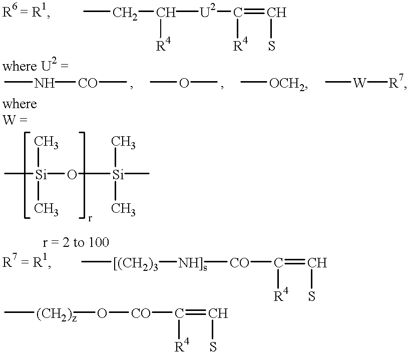
s=1 or 2
z=0 to 4,
—CO—[NH—(CH₂)₃]ₛ—W—R⁷
—CO—O—(CH₂)_{Z}—W—R⁷
—(CH₂)_{Z}—V—(CH₂)_{Z}—CH═CH—R¹, where
V=—O—CO—C₆H₄—CO—O— or —W—,
—COOR⁵ in the case of S=—COOR⁵ or COOMₐ,
and
V=—O—CO—C₆H₄—CO—O— or —W,
the ligands and indices each being as defined above;
optionally, at least one solvent,
optionally, an auxiliary.

21. A method for improving the resistance of a paint to weathering which comprises adding a pigment concentrate according to claim 20 to the paint.

22. The pigment concentrate according to claim 20, which further comprises a water-dispensable polymer, which is a polyacylate, polyurethane, or a polysiloxane.

23. An aqueous pigment concentrate comprising:
a pigment;
a copolymer obtained by polymerizing oxyalkyleneglycol-alkenyl ether monomers and unsaturated dicarboxylic acid derivatives comprising:
a) from about 10 to about 90 mol % of structural groups of the formula Ia and/or Ib 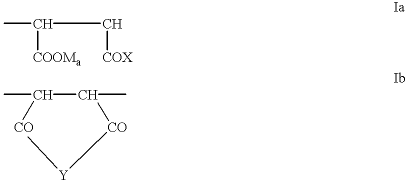
where
M=hydrogen, monovalent or divalent metal cation, ammonium ion, organic amine radical,
a=1 or, if M is a divalent metal cation, is ½,
X=—OMₐ or —O—(CₘHₗₘO)ₙ—(CₘHₗₘO)ₒ—R¹,
where
R¹=is H, an aliphatic hydrocarbon radical a cycloaliphatic hydrocarbon, an aryl radical which is unsubstituted or substituted,
l=1 or 2,
m=2 to 18,
the index on the hydrogen atom being formed by the product of l and m, and
n=0 to 100, and
o=0 to 100,
—NHR² and/or —NR₂² where
R²=R¹ or —CO—NH² and also
—Q¹N—Q—NQ³Q⁴, where
Q¹ is a hydrogen atom or a monovalent hydrocarbon radical;
Q² is a divalent alkylene radical;
Q³ and Q⁴ are aliphatic and/or alicyclic alkyl radicals; and
unoxidized or oxidized to —Q¹N—Q²—N(+)o(−)Q³Q⁴,
Y═O, NR², R² being as defined above, or N—Q²—NQ³Q^{4,}
where
Q², Q³ and Q⁴ being as defined above,
b) from about 1 to about 89 mol % of structural groups of the formula IIa or IIb 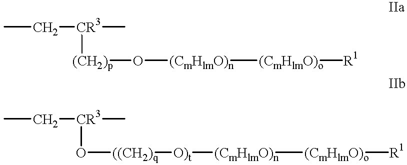
in which
R³=H aliphatic hydrocarbon radical,
p=0 to 3,
q=0 to 6, t=0 to 3, and
R¹ and l, m, n and o are as defined above,
c) about 0.1 to about 10 mol % structural groups of the formula IIIa or IIIb 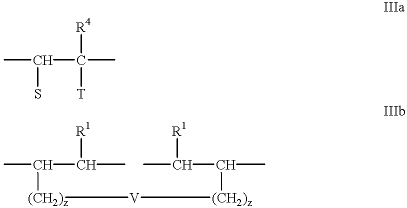
where
R⁴=H, CH₃
S=—H,—COOMₐ, —COOR⁵
where R⁵=aliphatic hydrocarbon radical; cycloaliphatic hydrocarbon radical; aryl radical.
T=—U¹—O—(CₘHₗₘO)ₙ—(CₘHₗₘO)ₒ—R⁶
where l=1 or 2, m=2 to 18, and
n=0 to 100 and o=0 to 100,
U¹=—CO—NH—, —O—, CH₂O—, 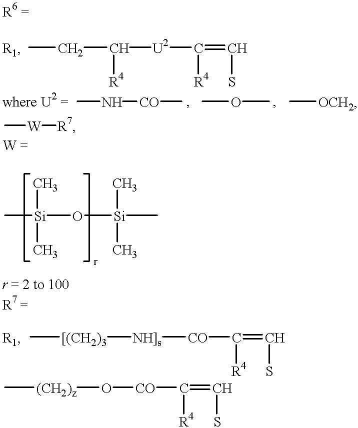
where
s=1 or 2
z=0 to 4,
—C—[NH—(CH₂)₃]ₛ—W—R⁷
—CO—O—(CH₂)_{Z}—W—R⁷
—(CH₂)_{Z}—V—(CH₂)_{Z}—CH═CH—R¹, where
V=—O—CO—C₆H₄—CO—O— or —W—,
—COOR⁵ in the case of S=—COOR⁵ or COOMₐ,
and
V=—O—CO—C₆H₄—CO—O— or —W,
the ligands and indices each being as defined above wherein the polymerization occurs in aqueous solution at a temperature of from about 20 to about 100° C. in the presence of a free-radical initiator,
water;
optionally, a co-solvent; and
optionally, an auxiliary.

24. A process for dispensing a pigment for a paint, printing ink or pigment paste which comprises adding to the pigment a co-polymer obtained by polymerizing oxyalkyleneglycol-alkylenyl ether and unsaturated dicarboxylic acid derivatives comprising:
a) from about 10 to about 90 mol % of structural groups of the formula Ia and/or Ib 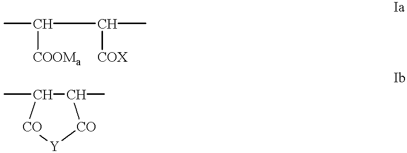
where
M=hydrogen, monovalent or divalent metal cation, ammonium ion, organic amine radical,
a=1 or, if M is a divalent metal cation, is ½,
X=—OMₐ or —O—(CₘHₗₘO)ₙ—(CₘHₗₘO)ₒ—R¹,
where
R¹=is H, an aliphatic hydrocarbon radical a cycloaliphatic hydrocarbon, an aryl radical which is unsubstituted or substituted,
l=1 or 2,
m=2 to 18,
the index on the hydrogen atom being formed by the product of l and m, and
n=0 to 100, and
o=0 to 100,
—NHR² and/or —NR₂² where
R²=R¹ or —CO—NH₂ and also
—Q¹N—Q²—NQ³Q⁴, where
Q¹ is a hydrogen atom or a monovalent hydrocarbon radical;
Q² is a divalent alkylene radical;
Q³ and Q⁴ are aliphatic and/or alicyclic alkyl radicals; and unoxidized or oxidized to —Q¹N—Q²—N(+)O(−)Q³Q⁴,
Y=O, NR², R² being as defined above, or N—Q²—NQ³Q⁴,
where
Q², Q³ and Q⁴being as defined above,
b) from about 1 to about 89 mol % of structural groups of the formula IIa or IIb 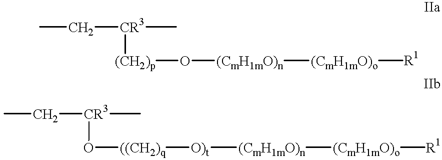
in which
R³=H, aliphatic hydrocarbon radical,
p=0 to 3,
q=0 to 6, t=0 to 3, and
R¹ and l, m, n and o are as defined above,
c) about 0.1 to about 10 mol % structural groups of the formula IIIa or IIIb 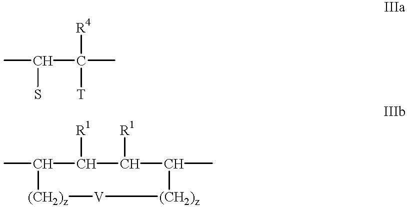
where
R⁴=H, CH₃
S=—H, —COOMₐ, —COOR⁵
where R⁵=aliphatic hydrocarbon radical; cycloaliphatic hydrocarbon radical; aryl radical,
T=—U¹—O—(CₘHₗₘO)ₙ—(CₘHₗₘO)ₒ—R⁶
where l=1 or 2, m=2 to 18, and
n=0 to 100 and o=0 to 100,
U¹=—CO—NH—, —O—, —CH₂O, 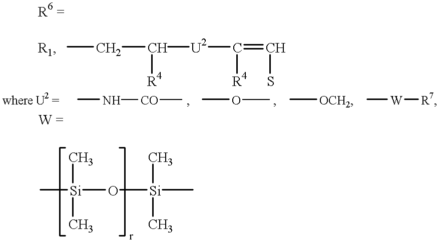
r=2 to 100
R⁷=R¹, 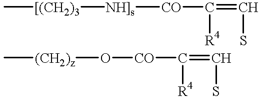
s=1 or 2
z=0 to 4,
—CO—[NH—(CH₂)₃]ₛ—W—R⁷
—CO—O—(CH₂)_{Z}—W—R⁷
—(CH₂)_{Z}—V—(CH₂)_{Z}—CH═CH—R¹, where
V=—O—CO—C₆H₄—CO—O— or —W—,
—COOR⁵ in the case of S=—COOR⁵ or COOMₐ,
and
V=—O—CO—C₆H₄—CO—O— or —W,
the ligands and indices each being as defined above wherein the polymerization occurs in aqueous solution at a temperature of from about 20° C. to about 100° C. in the presence of a free-radical initiator.
